(19) United States
(12) Patent Application Publication
(10) Pub. No.: US 2015/0353272 A1
(43) Pub. Date: Dec. 10, 2015

(54) CAPSULE FOR PREPARING A BEVERAGE

(71) Applicant: PSR PROFITABLE STRATEGIC REDEPLOYMENT SÀRL, Fribourg (CH)

(72) Inventors: Alain MARILLER, Les Monts-de-Corsier (CH); Jean-Paul GAILLARD, Cully (CH)

(21) Appl. No.: 14/653,648

(22) PCT Filed: Dec. 19, 2013
(86) PCT No.: PCT/IB2013/061130

§ 371 Date: Jun. 18, 2015

(30) Foreign Application Priority Data
Dec. 21, 2012 (IB) PCT/IB2012/057633

(51) Int. Cl. B65D 85/804; A47J 31/40

(52) U.S. Cl. CPC B65D 85/8043; A47J 31/407

(57) ABSTRACT

The invention relates to a capsule (1) for preparing a beverage, such as coffee, said capsule comprising a space intended to contain a concentrated dose, for example of ground coffee, an inlet and an outlet, both of which are connected to the space.

### REFERENCE TO AN EARLIER APPLICATION

The present application claims the priority of the earlier application No. PCT/IB2012/057633 filed Dec, 21, 2012 in the name of the same applicant as the present application, the content of that earlier application being incorporated by reference in its entirety into the present application.

### FIELD OF THE INVENTION

The invention concerns the preparation of beverages, for example coffee, by introduction of water into an element containing a concentrated dose of product, for example ground coffee, and by extraction of the mixture obtained in this way, and the devices used for this purpose.

### PRIOR ART

There are known various types of elements containing a concentrated dose into which water is introduced, mixed with the concentrated dose, and then extracted from the element.

The element takes the form of a capsule or other equivalent container, for example.

Water is introduced into the element by piercing at least one wall of the element. The beverage may be extracted by piercing, tearing or bursting a wall of the element or by another equivalent process.

The application WO 2011/024103 describes a sachet for the preparation of a beverage including an inlet orifice and an outlet orifice communicating with a volume containing a concentrated dose, for example of coffee.

### GENERAL DESCRIPTION OF THE INVENTION

One of the objectives of the invention is to offer an element for the preparation of a beverage that is improved relative to the elements known from the prior art.

Another objective is low cost, simple manufacture and operation and a biodegradable element.

These objectives are notably achieved by means of a capsule as defined in the claims.

In one embodiment, the capsule for the preparation of a beverage, for example coffee, includes at least one volume intended to contain a concentrated dose, for example of ground coffee, an inlet and an outlet, both communicating with said volume.

The inlet and the outlet may be disposed in the vicinity of each other or not.

In one embodiment, the capsule includes a first pocket containing the concentrated dose and a second pocket at least partly enveloping the first pocket.

The first pocket may at least partly form a filter or at least partly include a filter.

The capsule may include a flange to which are fixed the pockets and a film closing the capsule, said flange including at least one outlet passage for the prepared beverage.

The outer pocket may include at least one prepared beverage outlet instead of or in addition to the outlet of the flange.

The outlet of the pocket may be covered by at least one membrane.

The membrane(s) may include(s) one or more weakened or burstable area(s) and/or one or more area(s) of weaker fixing to the capsule or to the pocket.

The membrane(s) may be laminated to the capsule or to the pocket.

In one embodiment, the pockets are made from a flexible material and/or a rigid material and/or a semi-rigid material or even an elastic material and/or a combination of said materials.

In one embodiment, the elements forming the capsule are fixed by gluing, laminating, welding or any other equivalent process.

In one embodiment, the invention concerns a capsule cage in combination with a capsule according to the invention.

In one embodiment, the invention concerns a device for the extraction of a beverage adapted to use a capsule and/or a cage as defined in the present application.

In one embodiment, the invention concerns a device for the extraction of a beverage in combination with a capsule and/or a cage as defined in the present application.

### DETAILED DESCRIPTION OF THE INVENTION

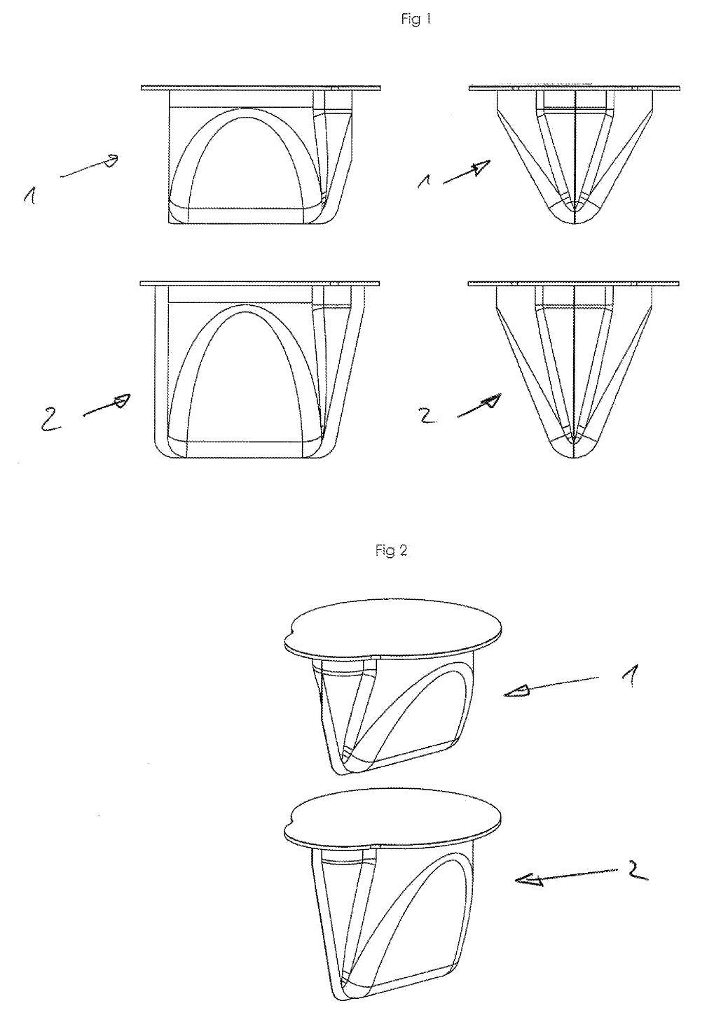

FIGS. 1 to 4 are side, front, perspective views from above and below of a capsule in accordance with one embodiment;

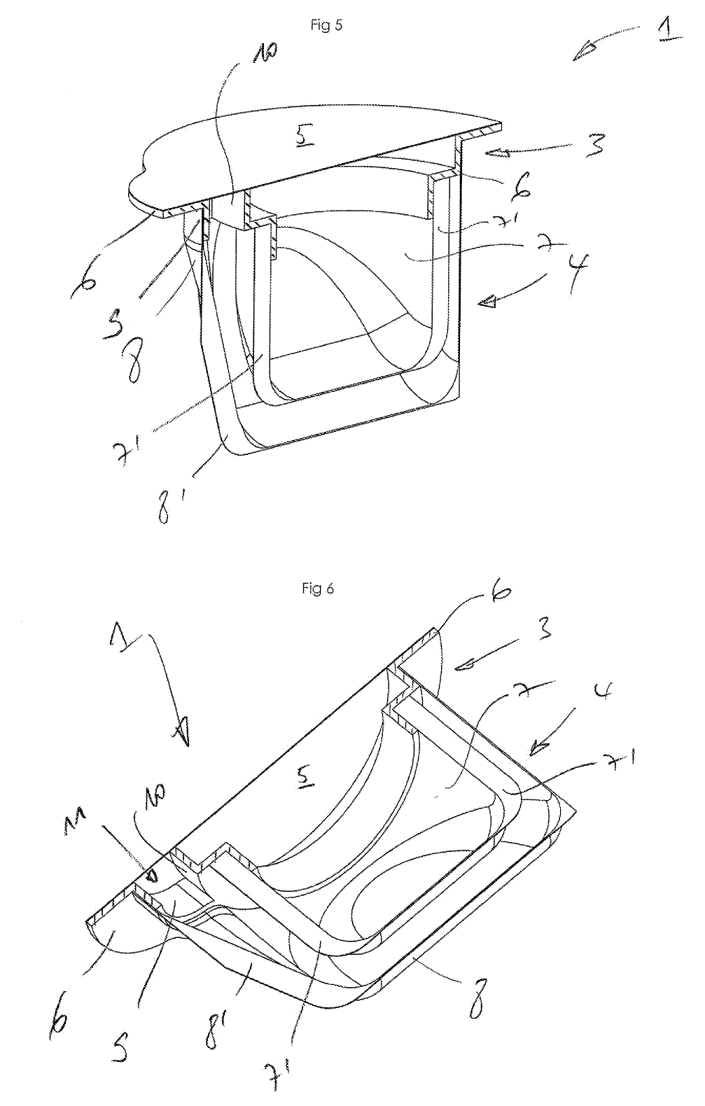

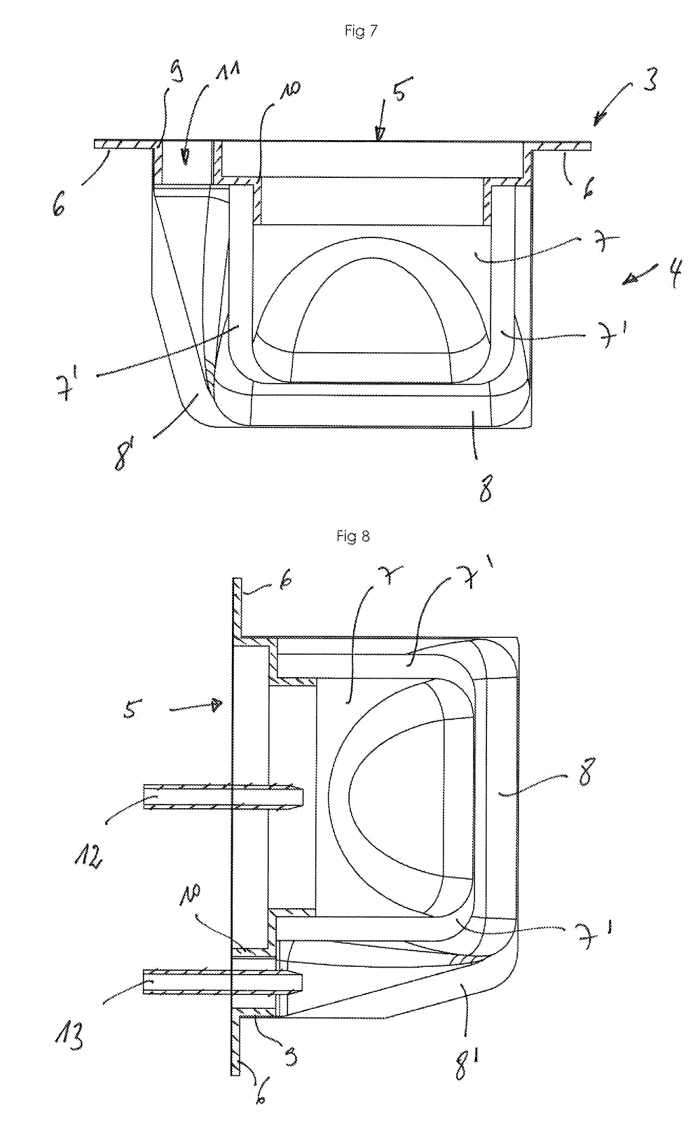

FIGS. 5 to 7 are sectional and perspective views of the capsule in accordance with one embodiment;

FIG. 8 is a sectional view of the capsule in accordance with one embodiment;

FIG. 9 is a sectional view of a cage into which a capsule is introduced;

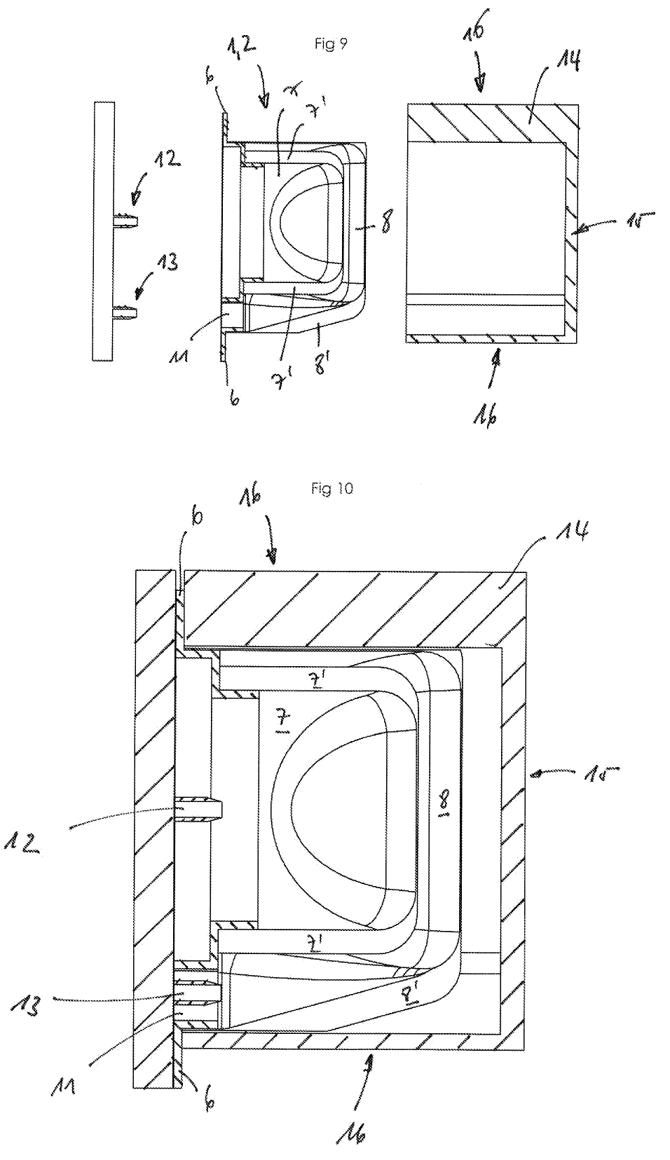

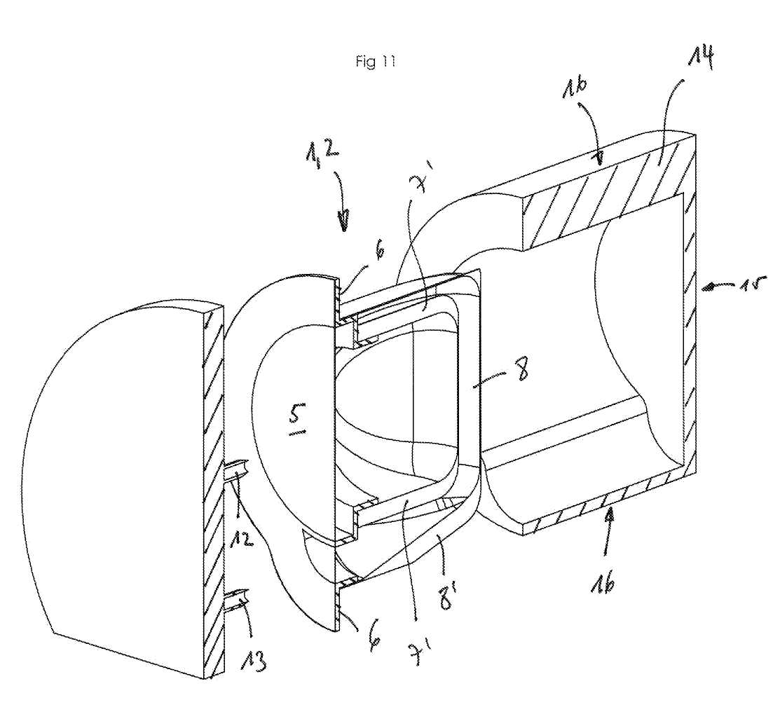

FIG. 10 is a sectional view of the state of the capsule in the cage in the position of use;

FIG. 11 is an exploded perspective view of the capsule, the cage and the needles.

The invention is described in more detail hereinafter by means of embodiments illustrated by the figures.

FIG. 1 shows side, front and perspective views of a capsule 1, 2 according to the invention. The difference between the two capsules 1 and 2 is their size, which makes it possible to use a different volume of product, for example ground coffee, to obtain a different quantity of beverage or a different concentration. The size of the capsule may also depend on the product contained therein and/or the required beverage.

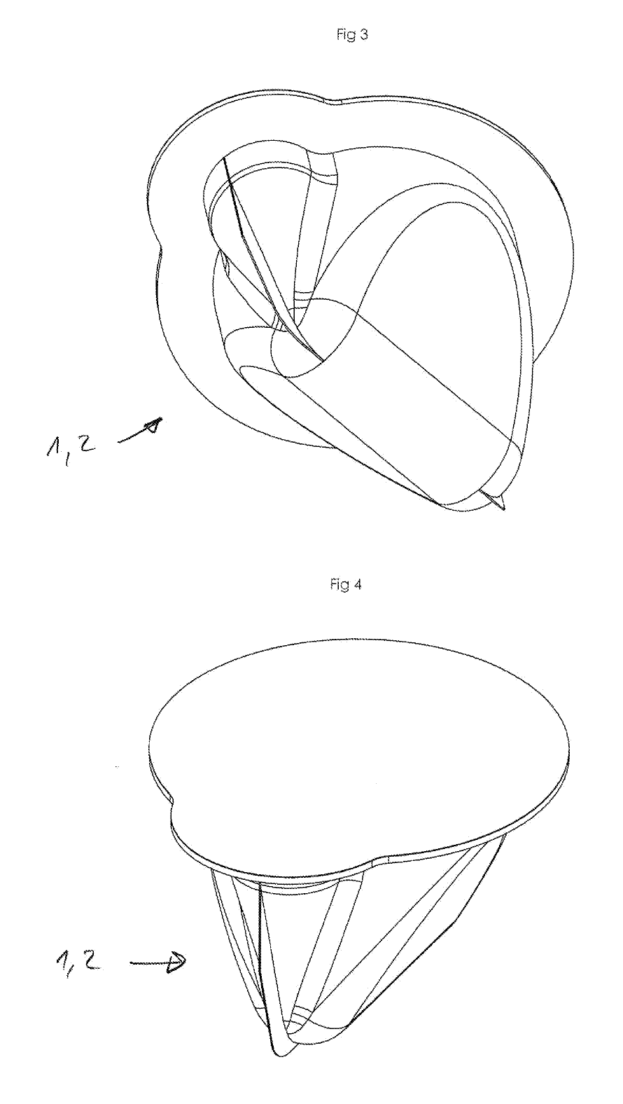

FIG. 2 shows perspective views of the capsule 1, 2 according to the invention.

FIGS. 3 and 4 show perspective views from below and from above of a capsule 1, 2 according to the invention.

FIGS. 5 to 7 show sectional and perspective views of the capsule 1, 2 according to the invention.

The general shape of the capsule is that of a mushroom or a cylinder with a cap 3 and a body 4.

The cap 3 includes a membrane 5, for example a film, intended to be pierced at the time of extraction of the beverage and attached to a flange 6 of “staircase” shape. An inner pocket 7 forming a filter is attached to this flange, forming a volume in which the product, for example ground coffee, is placed.

The inner pocket 7 may be made of any material and have any appropriate configuration for obtaining a filter effect: for example a filter as such (cloth, paper, etc.), a rigid or non-rigid shell with openings combined or not with a filter that covers the interior thereof either partly or completely. Any configuration that enables the retention of the product and the passage of a liquid through said inner pocket 7 producing a filter effect may be used in the context of the present invention.

The capsule 1, 2 further includes an outer pocket 8 which is made from a flexible, semi-rigid or rigid material, surrounds the inner pocket 7 and is fixed to the flange 6.

The pockets 7, 8 may be fixed to the flange by any appropriate means, as a function in particular of the materials used: gluing, welding, etc.

The flange 6 includes on at least one side a rim in two parts 9, 10 that form between them a passage 11 allowing liquid that has passed through the first pocket 7 into a space between the two pockets 7, 8 to leave the capsule.

FIG. 8 shows a sectional view of the capsule 1, 2 enabling how it works to be understood better.

A first needle 12 is introduced into the film 5 and pierces it for the introduction of liquid (for example hot water) into the first pocket 7 that contains the product used for the beverage (for example ground coffee). The liquid diffuses into the product and leaves the filter part formed by the pocket 7, for example by virtue of the effect of pressure. This liquid is recovered in the second pocket 8, in particular in the volume situated between the two pockets 7 and 8, and rises to the level of the passage 11, notably by virtue of the effect of pressure. In this passage there is also a needle 13 or other equivalent means for recovering said liquid so it can flow into a container, for example a cup.

The second needle 13 pierces the film 5 either at the same time as the first needle 12 or afterwards, for example so that a predetermined pressure can be reached in the capsule 1, 2 before the second needle 13 pierces the film 5.

The capsule 1, 2 may include a single outlet passage 11 or a plurality of passages distributed symmetrically or otherwise at the perimeter of the flange 6.

Alternatively, or additionally, other outlets/passages 11 may be provided on the outer pocket 8 at its edges and/or in its bottom and in other places in the capsule to enable evacuation of the liquid that has passed through the first pocket 7.

These outlets/passages may typically be pierced when using the capsule 1, 2 or may then be closed by a membrane attached to the pocket 8, said membrane being torn or unstuck or detached from the second pocket when using the capsule 1, 2. This tearing or detachment may be created by the internal pressure reached in the capsule or by external means placed in the capsule cage 14 for example that pierce the second pocket 8 at the appropriate time.

For example, this second pocket 8 may be deformed (e.g. inflated) when the liquid leaves the first pocket 7, this deformation or inflation of the outer pocket 8 creating an evacuation opening in said outer pocket 8 either by localized tearing thereof and/or piercing, for example by appropriate means (spikes, spears, etc.) situated on the capsule cage 14 (see FIGS. 9-11) and could be used when the deformation of the pocket 8 has reached a certain amplitude.

A combination of different types of passages/outlets 11 is of course possible within the scope of the present invention.

FIG. 9 shows in section a cage 14 in which a capsule 1, 2 according to the invention (as shown in FIGS. 1-8 for example) is introduced and the needles 12, 13.

FIG. 10 shows in section the state of the capsule 1, in the cage 14 with the needles 12, 13 in the position of use.

FIG. 11 shows an exploded perspective view of the capsule 1, 2, the cage and the needles 12, 13.

For manufacturing reasons, the pockets 7, 8 may include a lip 7′, 8′; for example the pockets 7, 8 may be formed of two parts that are assembled and fixed together by the lips 7′, 8′ (by welding, gluing or any other appropriate process).

After addition of the product in the inner pocket 7, the capsule 1 is closed by adding and fixing the film 5 to the flange 6. Alternatively, the pockets 7, 8 may be made in one piece.

The film 5 is attached to the flange 6 by a peripheral weld for example or by gluing or any appropriate means (lamination, etc.).

If a membrane is used for an outlet from the second pocket 8 (instead of the passage 11 or in addition to said passage), a portion of the weld between the membrane and the pocket 8 is preferably weaker so as to facilitate unsticking the membrane in the weakened area (and consequently at a chosen location). The membrane may also tear by virtue of the effect of the pressure of the liquid in the capsule 1. This tearing can be induced by weakening the membrane or by external means (spikes, etc.) situated externally, for example on the capsule cage 14. The same principles (weakening, external means, etc.) may be applied if it is the pocket 8 itself that is deformed and/or torn.

In such a case, it may be useful or even necessary to provide an outlet from the cage 14 in the bottom 15 and/or the sides 16 of the cage 14 for this purpose.

The elements of the capsule 1 may be made from any appropriate material: for example biodegradable materials, synthetic materials or metal. The body and the cap may be made in one piece or in two or more pieces.

The capsule, in particular the film 5, the pockets 7, 8 are preferably made from one or more flexible materials and/or rigid or semi-rigid materials or even elastic materials or a combination of these materials.

The capsule and/or its body may be different sizes as shown in FIGS. 1-2. The choice of size may be linked to the beverage prepared (for example coffee, tea, etc.) or to the required quantity of beverage (for example one or more cups, expresso or Americano, etc.).

The fixing of the elements forming the capsule is effected in accordance with appropriate processes, notably as a function of the materials used: welding (by heat, ultrasound, etc.), enchasing, clamping, gluing, lamination, etc.

To open it, the outlet membrane of the pocket may have one or more weakened and/or burstable areas or one or more areas of weaker fixing to the capsule in order to facilitate opening it in a controlled manner. Additional piercing means may also be provided, for example connected to the capsule cage 14 or otherwise.

The invention is not limited to the embodiments described, which are provided by way of illustrative example, and variations are possible within the scope of the protection claimed.

The exterior shape of a capsule is not limited to that shown in the figures and other (for example cylindrical) shapes are possible with the same functional elements as described in the present application.

It is not indispensible to use needles 12, 13 to pierce the film 5 and recover the prepared beverage. The film may be pierced by other means, for example by pressure, or torn or peeled off. It may include weakened or tearable areas or an additional membrane that is detached or torn (or subjected to another equivalent effect) to enable the introduction of liquid into the capsule 1, 2 and/or exit of the prepared beverage.

The embodiments described and their features may be combined with one another at will, as a function of circumstances.

1. A capsule (1) for the preparation of a beverage, for example coffee, including at least one volume intended to contain a concentrated dose, for example of ground coffee, an inlet and an outlet, both communicating with said volume.

2. The capsule as claimed in claim 1 wherein the inlet and the outlet are disposed in the vicinity of each other.

3. capsule as claimed in claim 1, wherein the inlet and the outlet are not in the vicinity of each other.

4. The capsule as claimed in claim 1 including a first pocket containing the concentrated dose and a second pocket at least partly enveloping the first pocket.

5. The capsule as claimed in claim 4, wherein the first pocket at least partly forms a filter or at least partly includes a filter.

6. The capsule as claimed in claim 1 including a flange to which are fixed the pockets and a film closing the capsule, said flange including at least one outlet passage for the prepared beverage.

7. The capsule as claimed in claim 1 wherein the outer pocket includes at least one prepared beverage outlet instead of or in addition to the outlet that is part of the flange.

8. The capsule as claimed in claim 7, wherein the outlet of the pocket is covered by at least one membrane.

9. The capsule as claimed in claim 8 wherein the membrane(s) include(s) one or more weakened area(s) and/or one or more area(s) of weaker fixing to the capsule or to the pocket.

10. The capsule as claimed in claim 9 wherein the membrane(s) is (are) laminated to the capsule or to the pocket.

11. The capsule as claimed in claim 1 wherein the film, the pockets are made from a flexible material and/or a rigid material and/or a semi-rigid material and/or a combination of said materials.

12. The capsule as claimed in claim 1, wherein the elements forming the capsule are fixed by gluing, laminating, welding or any other equivalent process.

13. A capsule cage in combination with a capsule as claimed in claim 1.

14. A device for the extraction of a beverage adapted to use a capsule as defined in claim 1.

15. A device for the extraction of a beverage in combination with a capsule as defined in claim 1.

16. A method of extraction of a beverage, such as coffee, using a capsule as defined in claim 1.
